(19) United States
(12) Patent Application Publication
(10) Pub. No.: US 2008/0165710 A1
(43) Pub. Date: Jul. 10, 2008

(54) Pilot structure for time division duplex downlink

(75) Inventors: Ulo Parts, Helsinki (FI); Kaj Jansen, Salo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/069,015

(22) Filed: Feb. 5, 2008

Related U.S. Application Data
(60) Provisional application No. 60/903,682, filed on Feb. 26, 2007.

(30) Foreign Application Priority Data
Apr. 4, 2003 (JP) 2003-101549

(51) Int. Cl. H04J 3/00

(52) U.S. Cl. 370/280

(57) ABSTRACT

The specification and drawings present a new method, system, apparatus and software product for using DL sub-frames with a unique pilot structure for TDD communications between a network element and a user equipment. In order to have equally good estimation for, e.g., channel, SIR and/or CQI estimation in the edges of a TDD sub-frame, the pilot structure should take into account UL/DL frame boundaries. In other words, a DL TDD sub-frame (e.g., 0.5 ms in duration) or sub-frames, adjacent in time domain to an UL TDD sub-frame can have higher total pilot energy than non-adjacent downlink TDD sub-frames by a pre-selected value or values.

### PRIORITY AND CROSS-REFERENCE TO RELATED APPLICATION

This application claims priority from U.S. Patent Application Ser. No. 60/903,682, filed on Feb. 26, 2007.

### TECHNICAL FIELD

This invention generally relates to communications, e.g., wireless/mobile communications, and more specifically to pilot structure for time division duplex (TDD) downlink communications.

### BACKGROUND ART

In long term evolution (LTE)) both TDD (time division duplex) and FDD (frequency division duplex) modes are under specification. In the FDD mode, the DL (downlink) pilots (transmitted from a network element to a user equipment) are continuously transmitted in every sub-frame of 0.5 ms. This is not possible in the TDD mode, because there will be UL (uplink) sub-frames as well. This can have impact on the overall system performance because, e.g., channel estimation is dependent on the available pilots.

In the FDD mode, the one unit over which channel estimation is done can be a sub-frame of length 0.5 ms. In order to achieve a good performance, the channel estimator can utilize the pilots of the sub-frame under detection and from other sub-frames, for instance, the next sub-frame (e.g., the pilot is located in the first symbol of the sub-frame). In the TDD mode, such method is not possible since there will be edges in places between DL and UL sub-frames, which may degrade the channel estimation as well as SIR (signal-to-interference ratio) estimation and CQI (channel quality indicator) estimation.

Up-to-date, the concept in LTE does not contain specific treatment of the pilots in the TDD mode, i.e., the pilots in the TDD mode are the same as in the FDD mode. In other words, no additional pilot subcarriers or no power boosting for pilots in the edges of the TDD sub-frames is implemented.

### DISCLOSURE OF THE INVENTION

According to a first aspect of the invention, a method, comprises: receiving one or more pilots in a downlink time division duplex sub-frame of a downlink signal by a user equipment from a network element, the downlink time division duplex sub-frame being adjacent in time domain to an uplink time division duplex sub-frame, wherein the downlink time division duplex sub-frame has higher total pilot energy than non-adjacent downlink time division duplex sub-frames comprised in the downlink signal by a pre-selected value; and making one or more estimations for the downlink time division duplex sub-frame using the one or more pilots by the user equipment.

According further to the first aspect of the invention, the one or more estimations may comprise at least one of: a channel estimation, a signal-to-interference ratio estimation and a channel quality indicator estimation.

Further according to the first aspect of the invention, the one or more pilots in the downlink time division duplex sub-frame may be comprised in a first and in a fifth symbol of the downlink time division duplex sub-frame.

Still further according to the first aspect of the invention, the higher total pilot energy may be provided using at least one of: an increased number of the one or more pilots in the downlink time division duplex sub-frame compared to the non-adjacent downlink time division duplex sub-frames comprised in the downlink signal, and an increased power of all or selected pilots out of the one or more pilots in the downlink time division duplex sub-frame compared to the non-adjacent downlink time division duplex sub-frames comprised in the downlink signal.

According yet further to the first aspect of the invention, the method may comprise: providing the one or more estimations to the network element. Still further, the method may further comprise: adjusting the pre-selected value using the one or more estimations.

According still further to the first aspect of the invention, a structure of the one or more pilots and the predetermined value may be defined by a specification or by the network element.

Yet still further according to the first aspect of the invention, the sub-frame may have a duration of 0.5 ms.

Still yet further according to the first aspect of the invention, the method may further comprise: providing in the downlink signal by the network element one or more further pilots in at least one downlink time division duplex sub-frame adjacent to the downlink time division duplex sub-frame, wherein the at least one downlink time division duplex sub-frame has higher total pilot energy than the non-adjacent downlink time division duplex sub-frames comprised in the downlink signal by a further pre-selected value, the further pre-selected value being less or equal to the pre-selected value, and wherein the one or more estimations are made using the one or more further pilots.

According to a second aspect of the invention, a computer readable storage structure embodying a computer program code thereon for execution by a computer processor with the computer program code, wherein the computer program code comprises instructions for performing the first aspect of the invention.

According to a third aspect of the invention, a user equipment, comprises: an uplink scheduling and signal generating module, responsive to one or more pilots comprised in a downlink time division duplex sub-frame of a downlink signal provided by a network element, configured to make one or more estimations for the downlink time division duplex sub-frame using the one or more pilots, the downlink time division duplex sub-frame being adjacent in time domain to an uplink time division duplex sub-frame, wherein the downlink time division duplex sub-frame has higher total pilot energy than non-adjacent downlink time division duplex sub-frames comprised in the downlink signal by a pre-selected value; and a module, configured to receive the downlink signal.

According further to the third aspect of the invention, the module may be configured to transmit a reporting signal comprising the one or more estimations.

Further according to the third aspect of the invention, the one or more estimations may comprise a channel estimation.

Still further according to the third aspect of the invention, the one or more estimations may comprise at least one of: a channel estimation, a signal-to-interference ratio estimation and a channel quality indicator estimation.

According yet further to the third aspect of the invention, the higher total pilot energy may be provided using an increased number of the one or more pilots in the downlink time division duplex sub-frame compared to the non-adjacent downlink time division duplex sub-frames comprised in the downlink signal.

According still further to the third aspect of the invention, the higher total pilot energy may be provided using an increased power of all or selected pilots out of the one or more pilots in the downlink time division duplex sub-frame compared to the non-adjacent downlink time division duplex sub-frames comprised in the downlink signal.

According yet further still to the third aspect of the invention, the one or more pilots in the downlink time division duplex sub-frame may be comprised in a first and in a fifth symbol of the downlink time division duplex sub-frame.

According further still to the third aspect of the invention, the pre-selected value may be adjusted by the network element using the one or more estimations.

Yet still further according to the third aspect of the invention, a structure of the one or more pilots and the predetermined value may be defined by a specification or by the network element.

Still further still according to the third aspect of the invention, an integrated circuit may comprise the uplink scheduling and signal generating module and the module configured to receive the downlink signal.

Still yet further still according to the third aspect of the invention, the uplink scheduling and signal generating module may be configured to response to one or more further pilots comprised in at least one downlink time division duplex sub-frame adjacent to the downlink time division duplex sub-frame, wherein the at least one downlink time division duplex sub-frame has higher total pilot energy than the non-adjacent downlink time division duplex sub-frames comprised in the downlink signal by a further pre-selected value, the further pre-selected value being less or equal to the pre-selected value, and wherein the one or more estimations are made using the one or more further pilots.

According to a fourth aspect of the invention, a user equipment, comprises: means for managing, responsive to one or more pilots comprised in a downlink time division duplex sub-frame of a downlink signal provided by a network element, configured to make one or more estimations for the downlink time division duplex sub-frame using the one or more pilots, the downlink time division duplex sub-frame being adjacent in time domain to an uplink time division duplex sub-frame, wherein the downlink time division duplex sub-frame has higher total pilot energy than non-adjacent downlink time division duplex sub-frames comprised in the downlink signal by a pre-selected value; and means for transmitting and receiving, for receiving the downlink signal.

According to a fifth aspect of the invention, a communication system, comprises: a network element, configured to provide one or more pilots in a downlink time division duplex sub-frame of a downlink signal, the downlink time division duplex sub-frame being adjacent in time domain to an uplink time division duplex sub-frame, wherein the downlink time division duplex sub-frame has higher total pilot energy than non-adjacent downlink time division duplex sub-frames comprised in the downlink signal by a pre-selected value; and a user equipment, responsive to the downlink signal, configured to make one or more estimations for the downlink time division duplex sub-frame using the one or more pilots.

According further to the fifth aspect of the invention, the network element may be a Node B, and the network element and the user equipment may be configured for wireless communications.

According to a sixth aspect of the invention, a network element, comprises: a scheduling and signal generating module, configured to provide one or more pilots in a downlink time division duplex sub-frame of a downlink signal to a user equipment, the downlink time division duplex sub-frame being adjacent in time domain to an uplink time division duplex sub-frame, wherein the downlink time division duplex sub-frame has higher total pilot energy than non-adjacent downlink time division duplex sub-frames comprised in the downlink signal by a pre-selected value; and a transmitter, configured to transmit the downlink signal.

According further to the sixth aspect of the invention, the network element may further comprise: a receiver, configured to receive a reporting signal comprising one or more estimations for the downlink time division duplex sub-frame performed by the user equipment using the one or more pilots.

Still further according to the sixth aspect of the invention, the scheduling and signal generating module may be configured to provide adjusting the pre-selected value using the one or more estimations.

### BRIEF DESCRIPTION OF THE DRAWINGS

For a better understanding of the nature and objects of the present invention, reference is made to the following detailed description taken in conjunction with the following drawings, in which:

FIG. 1 is a schematic representation of a DL TDD frame structure according to FIG. 6.2.1.2-4 of 3GPP TR25.814, v 1.5.0 with shown pilots identified by symbol “P” in selected sub-frames, according to an embodiment of the present invention;

FIGS. 2a is a schematic representation of DL and UL sub-frames;

FIGS. 2b-2f are schematic representations of selected DL sub-frame shown in FIG. 2a: with a conventional pilot structure (FIG. 2b), with increased number of pilots (FIG. 2c), with increased pilot power of pilots (FIG. 2d), and with simultaneous increase in pilot power and number of pilots (FIGS. 2e-2f), according to embodiments of the present invention;

FIG. 3 is a block diagram of a communication system for using TDD DL sub-frames with a unique pilot structure for TDD communications, according to an embodiment of the present invention; and

FIG. 4 is a flow chart for using TDD DL sub-frames with a unique pilot structure for TDD communications, according to an embodiment of the present invention.

### MODES FOR CARRYING OUT THE INVENTION

A new method, system, apparatus and software product are presented for using DL (downlink) sub-frames with a unique pilot structure for TDD (time division duplex) communications between a network element (e.g., a Node B) and a user equipment. In order to have equally good estimation for, e.g., channel estimation, signal-to-interference ratio (SIR) estimation and/or a channel quality indicator (CQI) estimation in the edges of a TDD sub-frame, the pilot structure should take into account the UL/DL frame boundaries, as described herein. In other words, a DL TDD sub-frame (e.g., 0.5 ms in duration) or sub-frames, adjacent in time domain to an UL (uplink) TDD sub-frame can have higher total pilot energy than non-adjacent downlink TDD sub-frames by a pre-selected value or values (i.e., the pre-selected value can be different for different adjacent sub-frames as described herein).

According to an embodiment of the present invention, one approach would be to have higher density of pilots in the edges of DL parts of the frame so that the performance does not degrade in the TDD DL sub-frames located on these edges. For example currently one possibility is to have every pilot in 6^{th} subcarrier per Tx (transmitter) antenna. Assuming that mentioned allocation of pilots (i.e., every 6^{th} subcarrier) is sufficient for the FDD mode, the density of pilots in the edges of the DL TDD sub-frame can be larger, for example every 4^{th} subcarrier. In other words, higher total pilot energy can be provided using an increased number of pilots in the downlink TDD sub-frame in the edges of DL parts of the frame. In another embodiment, the pilot density can be kept constant, but more power can be allocated to the pilot (i.e., pilot boosting), i.e., using increased power of all or selected pilots. According to a further embodiment, both pilot density and allocated power to pilot subcarriers can be increased/changed.

According to a further embodiment of the present invention, the pilot structure can be altered in several adjacent DL sub-frames, e.g., gradually increasing the pilot energy in sub-frames closer to the edge of the DL parts of the frame, i.e., typically the DL sub-frame closer to the edge can have a higher pilot energy than the the DL sub-carrier further from the edge but still higher than “normal” DL sub-frames.

Moreover, cccording to an embodiment of the present invention, the pilot structure as well as said pre-selected value or values (if more than one adjacent sub-frames with different pilot energies are used) for increasing the total pilot energy can be defined by a specification (i.e., standardization) or by the network or network element (e.g., Node B). If not standardized, these parameters can be pre-selected or dynamically defined, for example, by the network (e.g., based on the estimation performed and transmitted to the network element by the user equipment).

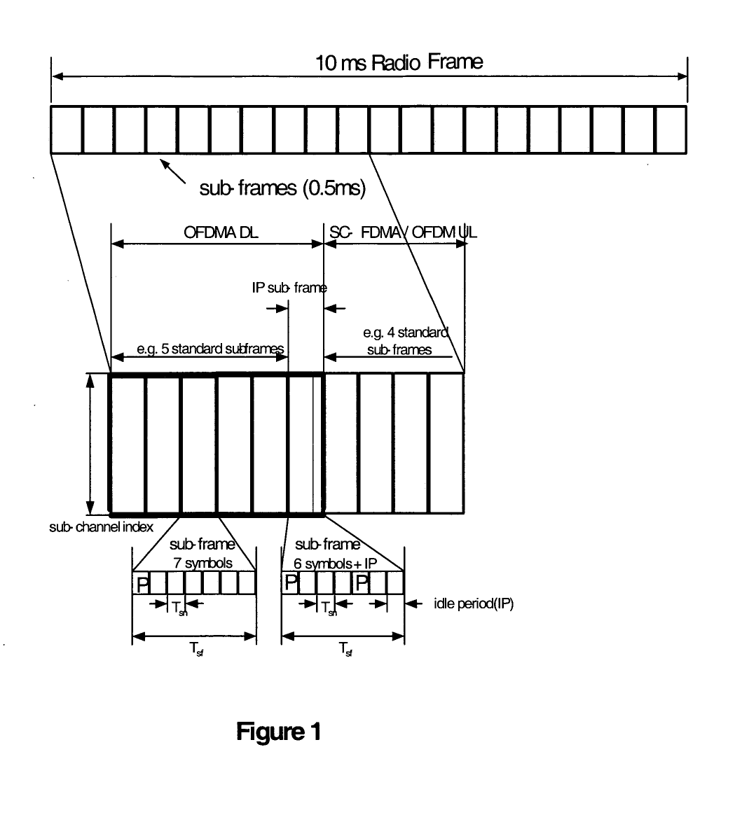

FIG. 1 shows an example among others of a schematic representation of a DL TDD frame structure according to FIG. 6.2.1.2-4 of 3GPP (3d Generation Partnership Project) TR25.814, v 1.5.0 with shown pilots identified by symbol “P” in selected sub-frames, according to an embodiment of the present invention. The FIG. 1 is slightly edited compared to that in TR25.814 document to show symbols comprising pilots in order to explain the embodiments described herein.

A downlink part of the frame comprising 6 sub-frames is highlighted and shown in the middle of the FIG. 1. According to embodiments of the present invention, the pilot structure can be changed in the sub-frames 1 and 6 in FIG. 1. Two symbols in the sixth sub-frame (which is adjacent to an uplink sub-frame) are marked with “P” to indicate that pilots are positioned in those symbols (the first and the fifth symbols). Other DL sub-frames can have a pilot structure with only one pilot as shown for the third DL sub-frame.

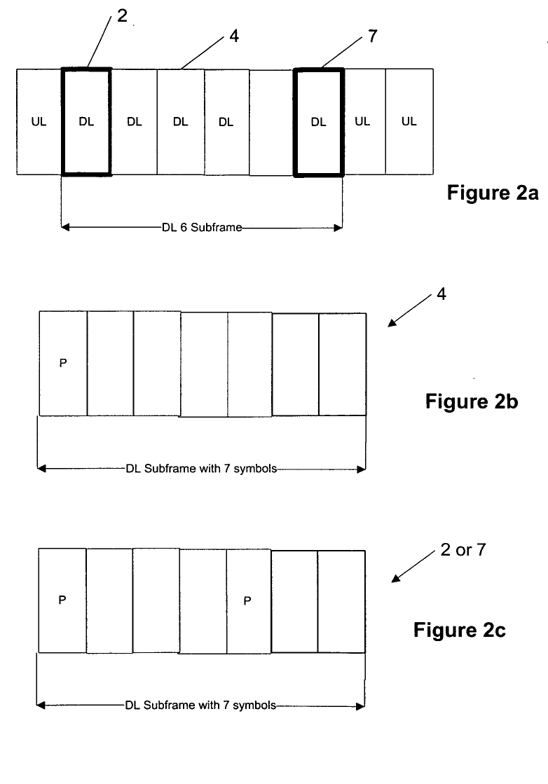

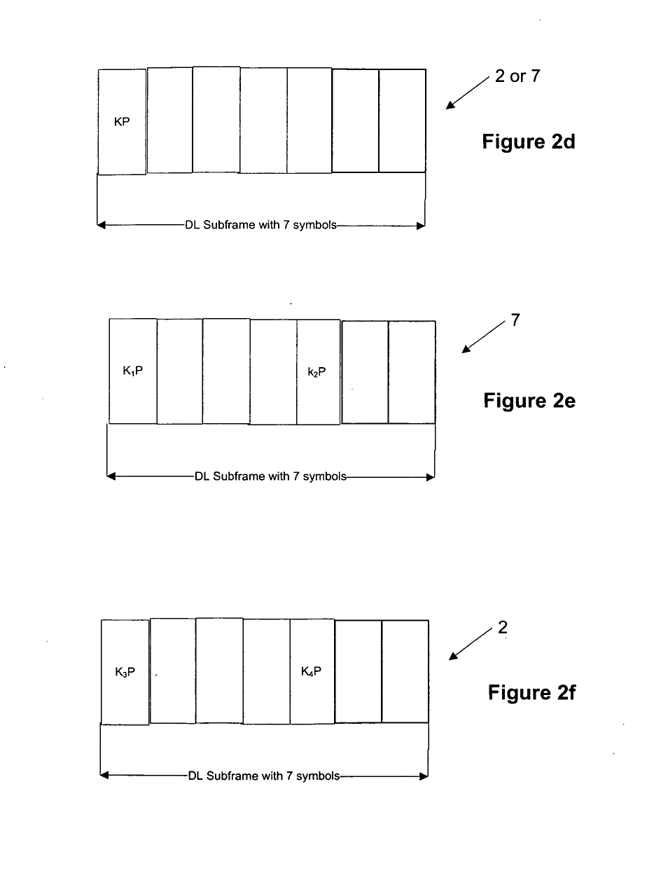

FIGS. 2a shows an example of a sequence of DL and UL TDD sub-frames, wherein DL sub-frames 2 and 7 are adjacent to UL sub-frames and FIGS. 2b-2f show examples among many others of schematic representations of selected DL sub-frame shown in FIG. 2a.

FIG. 2b shows a conventional pilot structure with one pilot (i.e., one symbol comprising one pilot) in the first symbol of a sub-frame 4. FIG. 2c shows an example with increased number of pilots (two pilots instead of one) in the first and in the fifth symbols in the DL sub-frames 2 and 7 (adjacent to the UL sub-frames), according to one embodiment of the invention. Moreover, in FIG. 2d, instead of increasing the number of pilots, the pilot power is increased by a factor of K (K is larger than 1) in the DL sub-frames 2 and 7, according to another embodiment described herein. FIGS. 2e-2f demonstrate a further embodiment, wherein the pilot number and pilot power can be simultaneously changed (e.g., increased): FIG. 2e is for the sub-frame 2 with corresponding coefficients K₁ and K₂ for the pilot power changes, and FIG. 2e is for the sub-frame 7 with corresponding coefficients K₃ and K₄. Coefficients K₁, K₂, K₃ and K₄ can be equal or, in general, can have different values. These coefficients typically can be larger than 1, but that is not required as long as K₁P+K₂P>P and K₃P+K₄P>P, wherein P is the original pilot power of “nonadjacent” sub-frames (e.g., of the sub-frame 4).

FIGS. 2a-2f demonstrate only few implementation examples and a variety of different scenarios are possible based on the principles outlined herein. In one embodiment described herein, the pilot structure can be altered in several adjacent DL sub-frames, e.g., gradually increasing the pilot energy in sub-frames closer to the edge of the DL parts of the frame. For example, the sub-frames 4 and 5 shown in FIG. 2a may have on pilot each (or equivalent to one energy unit), the sub-frames 3 and 6 shown in FIG. 2a may have two pilots each (or equivalent to two energy units), and the sub-frames 2 and 7 shown in FIG. 2a may have three pilots each (or equivalent to three energy units).

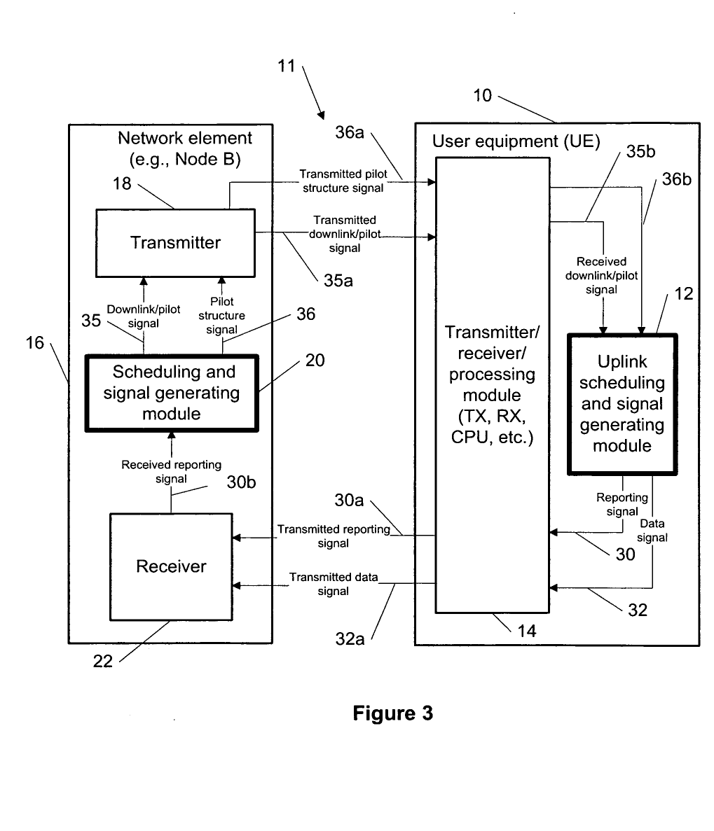

FIG. 3 shows an example among others of a block diagram of a communication system 11 (e.g., the wireless/mobile communication system) for using TDD DL sub-frames with a unique pilot structure for the TDD communications, according to an embodiment of the present invention.

In the example of FIG. 3, a user equipment 10 comprises an uplink scheduling and signal generating module 12 and a transmitter/receiver/processing module 14. The module 12 can be generally viewed as means for managing and a structural equivalence (or an equivalent structure) thereof. Also, the module 14 can generally be transmitting and/or receiving means, e.g., a transceiver, or a structural equivalence (or equivalent structure) thereof. The user equipment 10 can be a wireless device, a portable device, a mobile communication device, a mobile phone, etc. In the example of FIG. 3, a network element 16 (e.g., a Node B) can comprise a transmitter 18, a scheduling and signal generating module 20 and a receiver 22.

According to an embodiment of the present invention, the scheduling and signal generating module 20 can provide a TDD downlink/pilot signal 35 with a pilot structure according to embodiments of the present invention described herein (see FIGS. 2c-2f) and, if necessary, a pilot structure signal 36 which can be needed if the pilot structure is provided by the network element 16 as described herein. The signal 36 may not be needed if the DL pilot structure is defined by the specification such that the user equipment is aware of the pilot structure in advance. The signals 35 and 36 are then transmitted and forwarded using corresponding signals 35a and 36a, and 35b and 36b to the module 12. The module 12 then can perform corresponding estimations (e.g., channel, SIR or CQI estimation) and can provide a reporting signal 30 along with the TDD uplink data signal 32. The information comprised in the signals 30 and 32 is then transmitted by the module 14 to the receiver 22 of the Node B in the uplink using signal 30a, and 32a. The signal 30a, after being received, can be forwarded the module 20 for further processing and analysis and, if necessary, for adjusting the pilot structure/power in the downlink/pilot signal 35.

According to an embodiment of the present invention, the module 12, 14 or 20 can be implemented as a software or a hardware module or a combination thereof. Furthermore, the module 12, 14 or 20 can be implemented as a separate module/block or can be combined with any other standard module/block of the user equipment 10 or the network element 16, respectively, or it can be split into several modules/blocks according to their functionality. The transmitter/receiver/processing module 14 can be implemented in a plurality of ways and typically can include a transmitter, a receiver, a CPU (central processing unit), etc. The transmitter and receiver can be combined, for example, in one module such as transceiver, as known in the art. The module 14 can provide an effective communication of the module 12 with the network element 16. All or selected modules of the user equipment 10 can be implemented using an integrated circuit, and all or selected blocks and/or modules of the network element 16 can be implemented using an integrated circuit as well.

It is noted that the network element 16, for the purposes of understanding of various embodiments of the present invention, can be broadly interpreted such that the network element 16 can comprise features attributed to both the Node B and a radio network controller (RNC). Specifically, the module 20 can be located in the RNC (then the signaling from the RNC is forwarded to the user equipment by the Node B) or in the Node B, whereas the block 22 is located in the Node B.

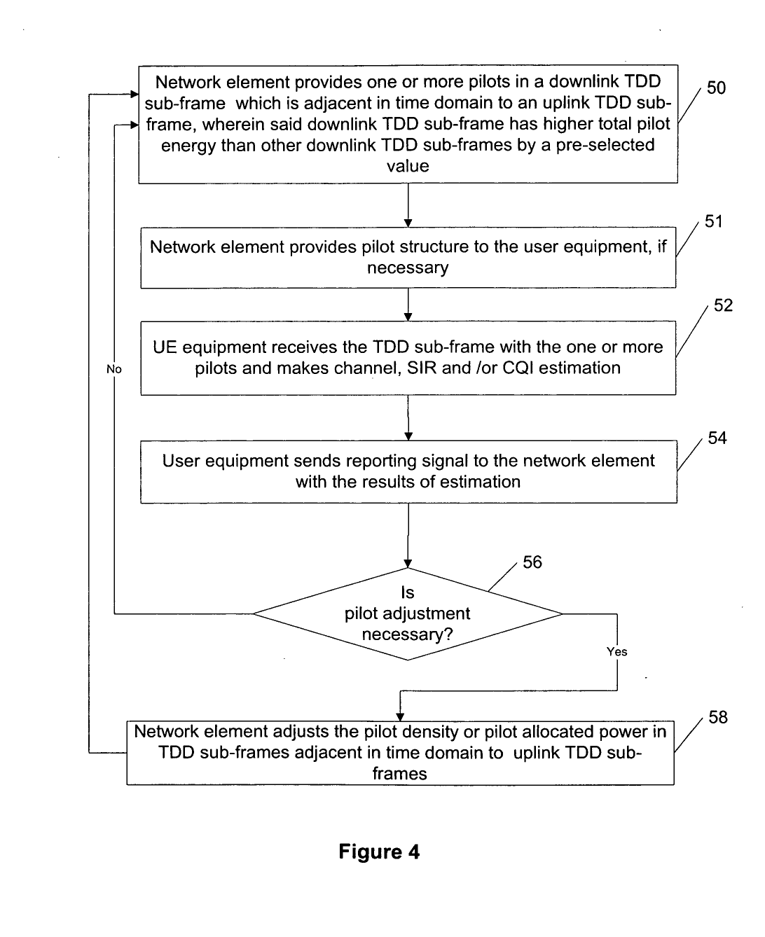

FIG. 4 shows an example of a flow chart for using TDD DL sub-frames with a unique pilot structure for the TDD communications in a communication system (e.g., the wireless/mobile communication system), according to an embodiment of the present invention.

The flow chart of FIG. 4 only represents one possible scenario among others. The order of steps shown in FIG. 4 is not absolutely required, so generally, the various steps can be performed out of order. In a method according to an embodiment of the present invention, in a first step 50, the network element provides one or more pilots in a downlink TDD sub-frame (of a downlink signal) which is adjacent in time domain to an uplink TDD sub-frame, wherein said downlink TDD sub-frame has higher total pilot energy than non-adjacent downlink TDD sub-frames by a pre-selected value, according to various embodiments as described herein. It is noted that according to the further embodiment described herein, the network element can provide one or more further pilots in at least one more downlink TDD sub-frame adjacent to said downlink TDD sub-frame with higher total pilot energy than the non-adjacent downlink TDD sub-frames comprised in the downlink signal by a further pre-selected value, wherein the further pre-selected value is less or equal to said pre-selected value, as described herein.

In a next step 51, if necessary, the network element provides a signal comprising pilot structure to the user equipment. In a next step 52, the user equipment receives the TDD sub-frame and makes channel, SIR and/or CQI estimation for said sub-frame using one or more pilots and possibly one or more further pilots as described herein. In a next step 54, the user equipment sends reporting signal to the network element with the results of this estimation.

In a next step 56, it may be determined by the network whether the pilot adjustment is necessary based on the estimation results comprised in the reporting signal (this step is optional). If that is not the case, the process goes back to step 50. If, however, it is determined that the pilot adjustment is necessary, in a next step 58, the network element adjusts the pilot density and/or pilot allocated power in the TDD sub-frames adjacent in time domain to the uplink TDD sub-frames and the process goes back to step 50.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is noted that various embodiments of the present invention recited herein can be used separately, combined or selectively combined for specific applications.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
receiving one or more pilots in a downlink time division duplex sub-frame of a downlink signal by a user equipment from a network element, said downlink time division duplex sub-frame being adjacent in time domain to an uplink time division duplex sub-frame, wherein said downlink time division duplex sub-frame has higher total pilot energy than non-adjacent downlink time division duplex sub-frames comprised in said downlink signal by a pre-selected value; and
making one or more estimations for said downlink time division duplex sub-frame using said one or more pilots by said user equipment.

2. The method of claim 1, wherein said one or more estimations comprise at least one of: a channel estimation, a signal-to-interference ratio estimation and a channel quality indicator estimation.

3. The method of claim 1, wherein said one or more pilots in said downlink time division duplex sub-frame are comprised in a first and in a fifth symbol of said downlink time division duplex sub-frame.

4. The method of claim 1, wherein said higher total pilot energy is provided using at least one of:
an increased number of said one or more pilots in said downlink time division duplex sub-frame compared to said non-adjacent downlink time division duplex sub-frames comprised in said downlink signal, and
an increased power of all or selected pilots out of said one or more pilots in said downlink time division duplex sub-frame compared to said non-adjacent downlink time division duplex sub-frames comprised in said downlink signal.

5. The method of claim 1, further comprises:
providing said one or more estimations to said network element.

6. The method of claim 1, further comprises:
adjusting said pre-selected value using said one or more estimations.

7. The method of claim 1, wherein a structure of said one or more pilots and said predetermined value is defined by a specification or by the network element.

8. The method of claim 1, wherein said sub-frame has a duration of 0.5 ms.

9. The method of claim 1, further comprising: providing in said downlink signal by said network element one or more further pilots in at least one downlink time division duplex sub-frame adjacent to said downlink time division duplex sub-frame, wherein said at least one downlink time division duplex sub-frame has higher total pilot energy than said non-adjacent downlink time division duplex sub-frames comprised in said downlink signal by a further pre-selected value, said further pre-selected value being less or equal to said pre-selected value, and wherein said one or more estimations are made using said one or more further pilots.

10. A computer program product comprising: a computer readable storage structure embodying a computer program code thereon for execution by a computer processor with said computer program code, wherein said computer program code comprises instructions for performing the method of claim 1.

11. A user equipment, comprising:
an uplink scheduling and signal generating module, responsive to one or more pilots comprised in a downlink time division duplex sub-frame of a downlink signal provided by a network element, configured to make one or more estimations for said downlink time division duplex sub-frame using said one or more pilots, said downlink time division duplex sub-frame being adjacent in time domain to an uplink time division duplex sub-frame, wherein said downlink time division duplex sub-frame has higher total pilot energy than non-adjacent downlink time division duplex sub-frames comprised in said downlink signal by a pre-selected value; and
a module, configured to receive said downlink signal.

12. The user equipment of claim 11, wherein said module is configured to transmit a reporting signal comprising said one or more estimations.

13. The user equipment of claim 11, wherein said one or more estimations comprise a channel estimation.

14. The user equipment of claim 11, wherein said one or more estimations comprise at least one of: a channel estimation, a signal-to-interference ratio estimation and a channel quality indicator estimation.

15. The user equipment of claim 11, wherein said higher total pilot energy is provided using an increased number of said one or more pilots in said downlink time division duplex sub-frame compared to said non-adjacent downlink time division duplex sub-frames comprised in said downlink signal.

16. The user equipment of claim 11, wherein said higher total pilot energy is provided using an increased power of all or selected pilots out of said one or more pilots in said downlink time division duplex sub-frame compared to said non-adjacent downlink time division duplex sub-frames comprised in said downlink signal.

17. The user equipment of claim 11, wherein said one or more pilots in said downlink time division duplex sub-frame are comprised in a first and in a fifth symbol of said downlink time division duplex sub-frame.

18. The user equipment of claim 11, wherein said pre-selected value is adjusted by said network element using said one or more estimations.

19. The user equipment of claim 11, wherein a structure of said one or more pilots and said predetermined value is defined by a specification or by the network element.

20. The user equipment of claim 11, wherein an integrated circuit comprises the uplink scheduling and signal generating module and the module configured to receive said downlink signal.

21. The user equipment of claim 14, wherein said uplink scheduling and signal generating module is configured to response to one or more further pilots comprised in at least one downlink time division duplex sub-frame adjacent to said downlink time division duplex sub-frame, wherein said at least one downlink time division duplex sub-frame has higher total pilot energy than said non-adjacent downlink time division duplex sub-frames comprised in said downlink signal by a further pre-selected value, said further pre-selected value being less or equal to said pre-selected value, and wherein said one or more estimations are made using said one or more further pilots.

22. A user equipment, comprising:
means for managing, responsive to one or more pilots comprised in a downlink time division duplex sub-frame of a downlink signal provided by a network element, configured to make one or more estimations for said downlink time division duplex sub-frame using said one or more pilots, said downlink time division duplex sub-frame being adjacent in time domain to an uplink time division duplex sub-frame, wherein said downlink time division duplex sub-frame has higher total pilot energy than non-adjacent downlink time division duplex sub-frames comprised in said downlink signal by a pre-selected value; and
means for transmitting and receiving, for receiving said downlink signal.

22. A communication system, comprising:
a network element, configured to provide one or more pilots in a downlink time division duplex sub-frame of a downlink signal, said downlink time division duplex sub-frame being adjacent in time domain to an uplink time division duplex sub-frame, wherein said downlink time division duplex sub-frame has higher total pilot energy than non-adjacent downlink time division duplex sub-frames comprised in said downlink signal by a pre-selected value; and
a user equipment, responsive to said downlink signal, configured to make one or more estimations for said downlink time division duplex sub-frame using said one or more pilots.

23. The communication system of claim 22, wherein said network element is a Node B and the network element and the user equipment are configured for wireless communications.

24. A network element, comprising:
a scheduling and signal generating module, configured to provide one or more pilots in a downlink time division duplex sub-frame of a downlink signal to a user equipment, said downlink time division duplex sub-frame being adjacent in time domain to an uplink time division duplex sub-frame, wherein said downlink time division duplex sub-frame has higher total pilot energy than non-adjacent downlink time division duplex sub-frames comprised in said downlink signal by a pre-selected value; and
a transmitter, configured to transmit said downlink signal.

25. The network element of claim 24, further comprising: a receiver, configured to receive a reporting signal comprising one or more estimations for said downlink time division duplex sub-frame performed by said user equipment using said one or more pilots.

26. The network element of claim 24, wherein said scheduling and signal generating module is configured to provide adjusting said pre-selected value using said one or more estimations.
